(19) United States
(12) Patent Application Publication
(10) Pub. No.: US 2022/0411720 A1
(43) Pub. Date: Dec. 29, 2022

(54) COLOUR CARE DETERGENT COMPOSITIONS

(71) Applicant: The Procter & Gamble Company, Cincinnati, OH (US)

(72) Inventors: Francesco BARBERO, Torino (IT); Debora Berti, SESTO FIORENTINO (IT); Giulia Ottavia Bianchetti, Brussels (BE); Camilla Maria Cova, SESTO FIORENTINO (IT); Phillip Kyle Vinson, Fairfield, OH (US)

(21) Appl. No.: 17/847,298

(22) Filed: Jun. 23, 2022

(30) Foreign Application Priority Data
Jun. 24, 2021 (EP) 21181313.4
Mar. 31, 2022 (EP) 22165838.8

(51) Int. Cl. C11D 1/831; C11D 11/00; C11D 3/37

(52) U.S. Cl. CPC C11D 1/831; C11D 11/0017; C11D 3/3769; C11D 1/22

(57) ABSTRACT

The need for a detergent composition which provides reduced dye bleeding from fabrics, is met by formulating the composition using a combination of branched nonionic surfactant and cationic polymer.

### FIELD OF THE INVENTION

Laundry detergent compositions, especially liquid laundry detergent compositions or unit dose articles providing improved care of coloured fabric.

### BACKGROUND OF THE INVENTION

Laundry detergent compositions are formulated to provide good cleaning to fabrics: To keep white fabrics white, and to keep coloured fabrics bright. The laundry detergent compositions are also typically formulated to remove stains and soils. However, in addition to removing soils, the laundry detergent compositions have been known to also remove dyes from coloured fabrics, resulting in fading of coloured fabrics. In addition, the dyes can deposit onto other fabrics being washed in the same cycle, resulting in discoloration of the co-washed fabrics.

In order to limit dye transfer to co-washed fabrics, dye-transfer inhibiting (DTI) polymers are often incorporated into detergent compositions marketed for cleaning coloured fabrics. Typical dye-transfer inhibitors are typically based on polymers such as polyvinyl pyrrolidone homopolymers (PVP), polyvinyl pyrrolidone/polyvinyl imidazole copolymers (PVP/PVI), and poly-4-vinylpyridine N-oxide (PVNO). However, while such DTI polymers reduce dye-transfer to co-washed fabric, they do not prevent dye bleeding from fabrics which leads to dye-fading.

As such, a need remains for a detergent composition which provides reduced dye bleeding from fabrics.

WO2010025116A1 relates to stable colour maintenance and/or rejuvenation compositions comprising at least one cationic polymer and anionic surfactant, and methods for providing the same. WO2013070560A1 relates to surface treatment compositions comprising certain cationic polymer(s), anionic surfactant, one or more shielding salts and hydrophobic association disruptor, the surface treatment compositions comprises at least 6% by weight of cationic polymer, at least 6% by weight anionic surfactant, and at least 4% by weight of the shielding salt, the weight ratio of anionic surfactant to cationic polymer is between 0.5:1 and 4:1, the composition may also have a weight ratio of shielding salt to cationic polymer of between 0.3:1 and 3:1. WO01/72937A1 relates to a method of reducing dye loss during the laundry treatment of dyed fabrics using a laundry treatment composition comprising a water-soluble or water-dispersible rebuild agent for deposition onto a fabric during a treatment process wherein the material undergoes during the treatment process, a chemical change by which change the affinity of the material for the fabric is increased. WO2014139577A1 relates to a two-component colour detergent composition for use at low temperature comprising or consisting of a first component comprising at least one non-ionic surfactant, and a second component comprising at least one percarbonate (a bleach), and tetraacetylethylenediamine (TAED), as well as to a method for preparing such two-component colour detergent composition and to their use for cleaning laundry items, in particular coloured laundry items. WO2017/044749A1 relates to a laundry or cleaning composition comprising (i) from about 0.001 wt. % to about 50 wt. % of at least one cationic polymer selected from the group consisting of poly acrylamidopropyl trimethyl ammonium chloride Poly (APT AC), polydiallyl dimethyl ammonium chloride poly(DADMAC), copolymers of polyAPTAC, copolymers of polyDADMAC, terpolymers of polyAPTAC, and/or terpolymers of polyDADMAC; (ii) from about 0.01 wt. % to about 50 wt. % of at least one non-ionic surfactant; (iii) optionally, from about 0.001 wt. % to about 5 wt. % of at least one enzyme; and (iv) optionally, from about 0.01 wt. % to about 25 wt. % of at least one laundry or cleaning additive, wherein said composition is capable of exhibiting color wash fastness or color maintenance.

### SUMMARY OF THE INVENTION

The present invention relates to a laundry detergent composition comprising a surfactant system and cationic polymer, wherein the surfactant system comprises: a branched nonionic surfactant, and wherein the cationic polymer is selected from: poly (diallyldimethylammonium chloride); copolymer of diallyldimethylammonium chloride and acrylic acid; copolymer of acrylamide and methacrylamidopropyltrimethyl ammonium chloride; copolymer of acrylamide and diallyldimethylammonium chloride; copolymer of methacrylate, methacrylamidopropyltrimethyl ammonium chloride and acrylic acid; copolymer of acrylamide, methacrylamidopropyltrimethyl ammonium chloride and acrylic acid; copolymer of acrylamide, diallyldimethylammonium chloride, and acrylic acid; copolymer of acrylamide and N,N, N-trimethyl aminoethyl acrylate; copolymer of diallyldimethylammonium chloride and vinyl alcohol, and mixtures thereof, wherein the cationic polymer has a molecular weight of from 1,000 Da to 1,250,000 Da, wherein the branched nonionic surfactant selected from: Formula I: R1—CH(R2)—O—(PO)ₓ(EO)_{y}(PO)_{z}—H, wherein, in Formula I: R1 is a C4 to C14 alkyl chain, preferably C4 to C8, more preferably C6, R2 is a C1 to C7 alkyl chain, preferably a C1 to C5, more preferably C3 alkyl chain, x is from 0 to 10, preferably from 0 to 5, more preferably from 0 to 3, y is from 5 to 20, preferably from 6 to 15, more preferably from 7 to 12, z is from 0 to 20, preferably from 0 to 5, more preferably from 0 to 3, EO stands for ethoxylation and PO stands for propoxylation; Formula II: R1—CH(R2)CH2—O—(PO)ₓ(EO)_{y}(PO)_{z}—H, wherein in formula II: R1 is a C3 to C13 alkyl chain, preferably C3 to C7, more preferably C5, R2 is a C1 to C7 alkyl chain, preferably a C1 to C5, more preferably C3 alkyl chain, xis from 0 to 10, preferably from 0 to 5, more preferably from 0 to 3, y is from 5 to 20, preferably from 6 to 15, more preferably from 7 to 12, z is from 0 to 20, preferably from 0 to 5, more preferably from 0 to 3, EO stands for ethoxylation and PO stands for propoxylation; and mixtures thereof.

The present invention further relates to the use of a laundry detergent composition comprising a branched nonionic surfactant for improving the colour protection, preferably colour retention, of coloured fabrics during laundering.

### DETAILED DESCRIPTION OF THE INVENTION

The detergent compositions of the present invention have been found to result in reduced dye fading during laundering.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

All measurements are performed at 25° C. unless otherwise specified.

As used herein, the articles including “a” and “an” when used in a claim, are understood to mean one or more of what is claimed or described.

### Laundry Detergent Composition

The laundry detergent composition can be in any suitable form, such as liquid, paste, granular, solid, powder, or in conjunction with a carrier such as a substrate. Preferred laundry detergent compositions are either liquid or granular, with liquid being most preferred.

As used herein, “liquid detergent composition” refers to liquid detergent composition which is fluid, and preferably capable of wetting and cleaning a fabric, e.g., clothing in a domestic washing machine. As used herein, “laundry detergent composition” refers to compositions suitable for washing clothes. The composition can include solids or gases in suitably subdivided form, but the overall composition excludes product forms which are non-fluid overall, such as tablets or granules. The liquid laundry detergent composition preferably has a density in the range from 0.9 to 1.3 grams per cubic centimetre, more specifically from 1.00 to 1.10 grams per cubic centimetre, excluding any solid additives but including any bubbles, if present.

The composition can be an aqueous liquid laundry detergent composition. For such aqueous liquid laundry detergent compositions, the water content can be present at a level of from 5.0% to 95%, preferably from 25% to 90%, more preferably from 50% to 85% by weight of the liquid detergent composition.

The pH range of the detergent composition is from 6.0 to 8.9, preferably from pH 7 to 8.8.

The detergent composition can also be encapsulated in a water-soluble film, to form a unit dose article. Such unit dose articles comprise a detergent composition of the present invention, wherein the detergent composition comprises less than 20%, preferably less than 15%, more preferably less than 10% by weight of water, and the detergent composition is enclosed in a water-soluble or dispersible film. Such unit-dose articles can be formed using any means known in the art. Suitable unit-dose articles can comprise one compartment, wherein the compartment comprises the liquid laundry detergent composition. Alternatively, the unit-dose articles can be multi-compartment unit-dose articles, wherein at least one compartment comprises the liquid laundry detergent composition.

### Cationic Polymer

The cationic polymer is selected from the group consisting of: poly (diallyldimethylammonium chloride) (polyquaternium 6); copolymer of diallyldimethylammonium chloride and acrylic acid (such as polyquaternium 22); copolymer of acrylamide and methacrylamidopropyltrimethyl ammonium chloride; copolymer of acrylamide and diallyldimethylammonium chloride (polyquaternium 7); copolymer of methacrylate, methacrylamidopropyltrimethyl ammonium chloride and acrylic acid (polyquaternium 47); copolymer of acrylamide, methacrylamidopropyltrimethyl ammonium chloride and acrylic acid (polyquaternium 53); copolymer of acrylamide, diallyldimethylammonium chloride, and acrylic acid (polyquaternium 39); copolymer of acrylamide and N,N, N-trimethyl aminoethyl acrylate; copolymer of diallyldimethylammonium chloride and vinyl alcohol; and mixtures thereof, preferably from the group consisting of: the cationic polymer is selected from: poly (diallyldimethylammonium chloride) (such as polyquaternium 6); copolymer of diallyldimethylammonium chloride and acrylic acid (such as polyquaternium 22); copolymer of methacrylate, methacrylamidopropyltrimethyl ammonium chloride and acrylic acid (such as polyquaternium 47); and mixtures thereof, more preferably the cationic polymer is copolymer of diallyldimethylammonium chloride and acrylic acid (such as polyquaternium 22).

For copolymer of diallyldimethylammonium chloride and acrylic acid the preferred ratio of diallyldimethylammonium chloride to acrylic acid is between approximately 90:10 and 50:50. The preferred cationic polymer is a copolymer of diallyldimethylammonium chloride and acrylic acid at a 65/35 mole ratio with a molecular weight of approximately 450,000. The copolymer of diallyldimethylammonium chloride and acrylic acid may be further described by the nomenclature Polyquaternium-22 or PQ22 as named under the International Nomenclature for Cosmetic Ingredients. Copolymers of acrylamide and diallyldimethylammonium chloride may be further described by the nomenclature Polyquaternium-7 or PQ7 as named under the International Nomenclature for Cosmetic Ingredients.

Table 1 below includes cationic charge densities and monomer molecular weights for selected cationic polymers.

| | | | Cationic | |
|---|---|---|---|---|
| | | | charges | Charge |
| | Chemical | Monomer | per repeat | density |
| Polymer | description | mw | unit | (meq/g) |
| Polyquaternium | copolymer of | 161.67 | 30 | 2.17 |
| 22, neutralized | diallyldimethyl- | (DADMAC) | | |
| | ammonium chloride | 94.05 | | |
| | and acrylic acid | (acrylic acid, | | |
| | 65/35 mole ratio, | sodium | | |
| | neutralized | neutralized) | | |
| | with NaOH | | | |
| Polyquaternium | copolymer of | 161.67 | 65 | 4.99 |
| 22, un- | diallyldimethyl- | (DADMAC) | | |
| neutralized | ammonium chloride | 72.06 | | |
| | and acrylic acid | (acrylic | | |
| | 65/35 mole ratio | acid) | | |

The cationic polymer can be present at a level of from 0.1% to 10%, preferably 0.5% to 5.0%, more preferably from 1.0% to 2.5% by weight of the composition.

The cationic polymer has a molecular weight of from 1,000 Da to 1,250,000 Da, preferably from 100,000 Da to 1,000,000 Da, more preferably from 250,000 Da to 750,000 Da.

The cationic polymer can have a charge density in the range of 0.05 to 25 meq/g when calculated at pH 7. Without being bound by theory, the molecular weight, charge density, and presence of hydrophobic units within the polymer structure of the cationic polymer may affect the ability of the shielding salt to effectively prevent the polymer-surfactant complex from forming.

Moreover, the charge density may be in the range of 0.05 to 25 meq/g when calculated at pH 7, or preferably below 7.0 meq/g, more preferably below 5.0 meq/g, and even more preferably below 3.0 meq/g when calculated at pH 7. As used herein, “charge density” refers to the charge density of the final polymer and may be different from the monomer feedstock. Charge density may be calculated by dividing the number of net charges per repeating unit by the molecular weight of the repeating unit and then multiplying by 1000. It should be noted that the positive charges may be located on the backbone of the cationic polymer and/or on the side chains of the cationic polymer. In the case of cationic polymers with amine monomers, the charge density depends on the pH of the carrier and thus the charge density for comparison with this disclosure should be measured at pH of 7.

### Surfactant System

The laundry composition comprises a surfactant system at a level of from 2.5% to 60%, preferably from 5.0% to 25%, more preferably from 7.0% to 15% by weight of the composition.

Suitable surfactants as used herein means surfactants or mixtures of surfactants that provide cleaning, stain removing, or laundering benefit to soiled material. Suitable detersive surfactants can be: anionic surfactant, nonionic surfactant, zwitterionic surfactant, and combinations thereof.

The surfactant system comprises branched nonionic surfactant. The surfactant system can further comprise a surfactant selected from the group comprising: anionic surfactant, amphoteric surfactant, or mixtures thereof. As such, the surfactant system can comprise a combination of anionic and nonionic surfactant, more preferably a combination of anionic surfactant, nonionic surfactant, and amphoteric surfactant.

Preferably surfactants comprising saturated alkyl chains are used.

### Branched Nonionic Surfactant

The surfactant system can comprise branched nonionic surfactant at a level of from 0.1% to 12%, preferably from 0.5% to 10%, more preferably from 1.0% to 3.0% by weight of the composition.

Suitable branched nonionic surfactants can be derived from primary or secondary alcohols. The branched nonionic surfactant are selected from:

R1—CH(R2)—O—(PO)ₓ(EO)_{y}(PO)_{z}—H a) Formula I:

In Formula I, R1 is a C4 to C14 alkyl chain, preferably C4 to C8, more preferably C6; R2 is a C1 to C7 alkyl chain, preferably a C1 to C5, more preferably C3 alkyl chain; x is from 0 to 10, preferably from 0 to 5, more preferably from 0 to 3; y is from 5 to 20, preferably from 6 to 15, more preferably from 7 to 12; and z is from 0 to 20, preferably from 0 to 5, more preferably from 0 to 3, EO stands for ethoxylation and PO stands for propoxylation;

R1—CH(R2)CH₂—O—(PO)ₓ(E0)_{y}(PO)_{z}—H b) Formula II:

In formula II: R1 is a C3 to C13 alkyl chain, preferably C3 to C7, more preferably C5; R2 is a C1 to C7 alkyl chain, preferably a C1 to C5, more preferably C3 alkyl chain; x is from 0 to 10, preferably from 0 to 5, more preferably from 0 to 3; y is from 5 to 20, preferably from 6 to 15, more preferably from 7 to 12; and z is from 0 to 20, preferably from 0 to 5, more preferably from 0 to 3, EO stands for ethoxylation and PO stands for propoxylation.

Preferred branched non-ionic ethoxylates according to formula I are those available under the tradenames Tergitol® 15-S, with an alkoxylation degree of from 3 to 40. For instance Tergitol® 15-S-20 which has an average degree of alkoxylation of 20. Other suitable commercially available material according to formula I are the ones available under the tradename Softanol® M and EP series.

Preferred branched nonionic surfactants according to formula II are the Guerbet C10 alcohol ethoxylates with 7 or 8 EO, such as Ethylan® 1007 & 1008, and the Guerbet C10 alcohol alkoxylated nonionic surfactants (which are ethoxylated and/or propoxylated) such as the commercially available Lutensol® XL series (XL50, XL70. etc). Other exemplary alkoxylated branched nonionic surfactants include those available under the trade names: Lutensol® XP30, Lutensol® XP-50, and Lutensol® XP-80 available from BASF Corporation. In general, Lutensol® XP-30 can be considered to have 3 repeating ethoxy groups, Lutensol® XP-50 can be considered to have 5 repeating ethoxy groups, and Lutensol® XP-70 can be considered to have 7 repeating ethoxy groups. Other suitable branched nonionic surfactants include oxo branched nonionic surfactants such as the Lutensol® ON 50 (5 EO) and Lutensol® ON70 (7 EO). Other suitable branched nonionic surfactants include Plurafac® SLF 170 (3PO, 12EO, 15PO). Also suitable are:

the ethoxylated fatty alcohols originating from the Fischer & Tropsch reaction comprising up to 50% branching (40% methyl (mono or bi), 10% cyclohexyl) such as those produced from the Safol® alcohols from Sasol; ethoxylated fatty alcohols originating from the oxo reaction wherein at least 50% by weight of the alcohol is C2 isomer (methyl to pentyl) such as those produced from the Isalchem® alcohols or Lial® alcohols from Sasol.

### Further Nonionic Surfactant

The liquid detergent composition can comprise further nonionic surfactant. The level of further nonionic surfactant in the liquid detergent composition can be present at a level of less than 15 wt %, preferably less than 7.0 wt %, more preferably less than 5.0 wt %, and even more preferably less than 3.0 wt %. Most preferably, the composition is free of further nonionic surfactant. Suitable nonionic surfactants include, but are not limited to linear C12-C18 alkyl ethoxylates (“AE”) including the so-called narrow peaked alkyl ethoxylates and C6-C12 alkyl phenol alkoxylates (especially ethoxylates and mixed ethoxy/propoxy), block alkylene oxide condensate of C6-C12 alkyl phenols, alkylene oxide condensates of C8-C22 alkanols and ethylene oxide/propylene oxide block polymers (Pluronic—BASF Corp.), as well as semi polar nonionics (e.g., amine oxides and phosphine oxides) can be used in the present compositions. An extensive disclosure of these types of surfactants is found in U.S. Pat. No. 3,929,678.

Alkylpolysaccharides such as disclosed in U.S. Pat. No. 4,565,647 are also useful nonionic surfactants in the compositions of the invention.

Also suitable are alkyl polyglucoside surfactants.

Further nonionic surfactants of use include those of the formula R₁(OC₂H₄)ₙOH, wherein R₁ is a linear C10-C16 alkyl group or a C8-C12 alkyl phenyl group, and n is from preferably 3 to 80. In some embodiments, the nonionic surfactants may be condensation products of linear C12-C15 alcohols with from 5 to 20 moles of ethylene oxide per mole of alcohol, e.g., C12-C13 alcohol condensed with 6.5 moles of ethylene oxide per mole of alcohol

### Anionic Surfactant

The surfactant system can comprise anionic surfactant at a level of from 1.4% to 52%, preferably from 4.4% to 20%, more preferably from 5.9% to 11.5% of the liquid laundry detergent composition.

The surfactant system can further comprise an anionic surfactant, preferably selected from the group comprising: sulphonate surfactant, sulphate surfactant, or mixtures thereof, more preferably wherein the anionic surfactant comprises sulphonate surfactant and sulphate surfactant. Suitable anionic surfactants also include fatty acids and their salts, which are typically added as builders. However, by nature, every anionic surfactant known in the art of detergent compositions may be used, such as disclosed in “Surfactant Science Series”, Vol. 7, edited by W. M. Linfield, Marcel Dekker. However, the composition preferably comprises at least a sulphonic acid surfactant, such as a linear alkyl benzene sulphonic acid, but water-soluble salt forms may also be used. Alkyl sulphates, or mixtures thereof, are also preferred. A combination of linear alkyl benzene sulphonate and alkyl sulphate surfactant is particularly preferred, especially for improving stain removal.

Anionic sulphonate or sulphonic acid surfactants suitable for use herein include the acid and salt forms of alkylbenzene sulphonates, alkyl ester sulphonates, alkane sulphonates, alkyl sulphonated polycarboxylic acids, and mixtures thereof. Suitable anionic sulphonate or sulphonic acid surfactants include: C5-C20 alkylbenzene sulphonates, more preferably C10-C16 alkylbenzene sulphonates, more preferably C11-C13 alkylbenzene sulphonates, C5-C20 alkyl ester sulphonates, C6-C22 primary or secondary alkane sulphonates, C5-C20 sulphonated polycarboxylic acids, and any mixtures thereof, but preferably C11-C13 alkylbenzene sulphonates. The aforementioned surfactants can vary widely in their 2-phenyl isomer content.

Anionic sulphate salts suitable for use in the compositions of the invention include the primary and secondary alkyl sulphates, having a linear or branched alkyl or alkenyl moiety having from 9 to 22 carbon atoms or more preferably 12 to 18 carbon atoms. Also useful are beta-branched alkyl sulphate surfactants or mixtures of commercially available materials, having a weight average (of the surfactant or the mixture) branching degree of at least 50%.

Mid-chain branched alkyl sulphates or sulphonates are also suitable anionic surfactants for use in the compositions of the invention. Preferred are the C5-C22, preferably C10-C20 mid-chain branched alkyl primary sulphates. When mixtures are used, a suitable average total number of carbon atoms for the alkyl moieties is preferably within the range of from greater than 14.5 to 17.5. Preferred mono-methyl-branched primary alkyl sulphates are selected from the group consisting of the 3-methyl to 13-methyl pentadecanol sulphates, the corresponding hexadecanol sulphates, and mixtures thereof. Dimethyl derivatives or other biodegradable alkyl sulphates having light branching can similarly be used.

When used, the alkyl alkoxylated sulphate surfactant can be a blend of one or more alkyl ethoxylated sulphates. Suitable alkyl alkoxylated sulphates include C10-C18 alkyl ethoxylated sulphates, more preferably C12-C15 alkyl ethoxylated sulphates. The anionic surfactant can comprise alkyl sulphate surfactant, wherein the alkyl sulphate surfactant has an average degree of ethoxylation of from 0.5 to 8.0, preferably from 1.0 to 5.0, more preferably from 2.0 to 3.5.

Alternatively, the anionic surfactant can comprise alkyl sulphate surfactant, wherein the alkyl sulphate surfactant has a low degree of ethoxylation, having an average degree of ethoxylation of less than 0.5, preferably less than 0.1, and more preferably is free of ethoxylation. Preferred low ethoxylation alkyl sulphate surfactants do not comprise any further alkoxylation. Preferred low ethoxylation alkyl sulphate surfactants comprise branched alkyl sulphate surfactant.

The branched alkyl sulphate surfactant can comprise at least 20%, preferably from 60% to 100%, more preferably from 80% to 90% by weight of the alkyl chains of the branched alkyl sulphate surfactant of 2-branched alkyl chains. Such branched alkyl sulphates with 2-branched alkyl chains can also be described as 2-alkyl alkanol sulphates, or 2-alkyl alkyl sulphates. The branched alkyl sulphates can be neutralized by sodium, potassium, magnesium, lithium, calcium, ammonium, or any suitable amines, such as, but not limited to monoethanolamine, triethanolamine and monoisopropanolamine, or by mixtures of any of the neutralizing metals or amines. Suitable branched alkyl sulphate surfactants can comprise alkyl chains comprising from 10 to 18 carbon atoms (C10 to C18) or from 12 to 15 carbon atoms (C12 to C15), with 13 to 15 carbon atoms (C13 to C15) being most preferred. The branched alkyl sulphate surfactant can be produced using processes which comprise a hydroformylation reaction in order to provide the desired levels of 2-branching. Particularly preferred branched alkyl sulphate surfactants comprise 2-branching, wherein the 2-branching comprises from 20% to 80%, preferably from 30% to 65%, more preferably from 40% to 50% by weight of the 2-branching of methyl branching, ethyl branching, and mixtures thereof.

Suitable low ethoxylated branched alkyl sulphate surfactants can be derived from alkyl alcohols such as Lial® 145, Isalchem® 145, both supplied by Sasol, optionally blending with other alkyl alcohols in order to achieve the desired branching distributions.

Lower levels of dye removal from fabrics during laundering can be achieved while maintaining cleaning performance, when laundering the fabrics at temperatures of 30° C. or below when the fabrics are washed using compositions of the present invention comprising such low ethoxylated alkyl sulphate surfactants, especially when the low ethoxylated alkyl sulphate surfactants comprise the 2-branching as described above.

Processes to make such alkyl ether sulphate anionic surfactants may result in trace residual amounts of 1,4-dioxane by-product being present. The amount of 1,4-dioxane by-product within alkoxylated especially ethoxylated alkyl sulphates can be reduced. Based on recent advances in technology, a further reduction of 1,4-dioxane by-product can be achieved by subsequent stripping, distillation, evaporation, centrifugation, microwave irradiation, molecular sieving or catalytic or enzymatic degradation steps. An alternative is to use alkyl sulphate anionic surfactants which comprise only low levels of ethoxylation, or even being free of ethoxylation. As such, the alkyl sulphate surfactant can have a degree of ethoxylation of less than 1.0, or less than 0.5, or even be free of ethoxylation.

Other suitable anionic surfactants for use herein include fatty methyl ester sulphonates and/or alkyl polyalkoxylated carboxylates, for example, alkyl ethoxylated carboxylates (AEC).

The anionic surfactants are typically present in the form of their salts with alkanolamines or alkali metals such as sodium and potassium.

For improved stability and grease cleaning, the liquid detergent composition can comprise a combination of linear alkyl benzene sulphonate surfactant and alkyl sulphate surfactant, preferably such that the ratio of linear alkyl benzene sulphonate surfactant to alkyl alkoxylated sulphate surfactant is from 15:1 to 0.1:1, preferably from 10:1 to 0.3:1, more preferably from 5:1 to 1:1.

### Amphoteric and/or Zwitterionic Surfactant

The surfactant system can comprise amphoteric and/or zwitterionic surfactant at a level of from 0.1% to 2.0%, preferably from 0.1% to 1.0%, more preferably from 0.1% to 0.5% by weight of the liquid laundry detergent composition.

Suitable amphoteric surfactants include amine oxide surfactants. Amine oxide surfactants are amine oxides having the following formula : R₁R₂R₃NO wherein R₁ is an hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R₁ may be a saturated or unsaturated, substituted or unsubstituted linear or branched hydrocarbon chain.

Suitable amine oxides for use herein are for instance preferably C₁₂-C₁₄ dimethyl amine oxide (lauryl dimethylamine oxide), commercially available from Albright & Wilson, C₁₂-C₁₄ amine oxides commercially available under the trade name Genaminox® LA from Clariant or AROMOX® DMC from AKZO Nobel.

Suitable amphoteric or zwitterionic detersive surfactants include those which are known for use in hair care or other personal care cleansing. Non-limiting examples of suitable zwitterionic or amphoteric surfactants are described in U.S. Pat. Nos. 5,104,646, 5,106,609. Suitable amphoteric detersive surfactants include those surfactants broadly described as derivatives of aliphatic secondary and tertiary amines in which the aliphatic radical can be straight or branched chain and wherein one of the aliphatic substituents contains from 8 to 18 carbon atoms and one contains an anionic group such as carboxy, sulphonate, sulphate, phosphate, or phosphonate. Suitable amphoteric detersive surfactants for use in the present invention include, but are not limited to: cocoamphoacetate, cocoamphodiacetate, lauroamphoacetate, lauroamphodiacetate, and mixtures thereof.

### Optional Ingredients

The detergent composition may additionally comprise one or more of the following optional ingredients: external structurant or thickener, enzymes, enzyme stabilizers, cleaning polymers, bleaching systems, optical brighteners, hueing dyes, particulate material, perfume and other odour control agents, hydrotropes, suds suppressors, fabric care benefit agents, pH adjusting agents, dye transfer inhibiting agents, dye fixative polymers, preservatives, non-fabric substantive dyes and mixtures thereof In more preferred embodiments, the laundry detergent composition does not comprise a bleach.

External structurant or thickener: Preferred external structurants and thickeners are those that do not rely on charge—charge interactions for providing a structuring benefit. As such, particularly preferred external structurants are uncharged external structurants, such as those selected from the group consisting of: non-polymeric crystalline, hydroxyl functional structurants, such as hydrogenated castor oil; microfibrillated cellulose; uncharged hydroxyethyl cellulose; uncharged hydrophobically modified hydroxyethyl cellulose; hydrophobically modified ethoxylated urethanes; hydrophobically modified non-ionic polyols; and mixtures thereof.

Suitable polymeric structurants include naturally derived and/or synthetic polymeric structurants.

Examples of naturally derived polymeric structurants of use in the present invention include: microfibrillated cellulose, hydroxyethyl cellulose, hydrophobically modified hydroxyethyl cellulose, carboxymethyl cellulose, polysaccharide derivatives and mixtures thereof. Non-limiting examples of microfibrillated cellulose are described in WO 2009/101545 A1. Suitable polysaccharide derivatives include: pectine, alginate, arabinogalactan (gum Arabic), carrageenan, gellan gum, xanthan gum, guar gum and mixtures thereof.

Examples of synthetic polymeric structurants or thickeners of use in the present invention include: polycarboxylates, hydrophobically modified ethoxylated urethanes (HEUr), hydrophobically modified non-ionic polyols and mixtures thereof.

Preferably, the aqueous liquid detergent composition has a viscosity of 50 to 5,000, preferably 75 to 1,000, more preferably 100 to 500 mPa·s, when measured at a shear rate of 100 s−1, at a temperature of 20° C. For improved phase stability, and also improved stability of suspended ingredients, the aqueous liquid detergent composition has a viscosity of 50 to 250,000, preferably 5,000 to 125,000, more preferably 10,000 to 35,000 mPa·s, when measured at a shear rate of 0.05 s−1, at a temperature of 20° C.

Cleaning polymers: The detergent composition preferably comprises a cleaning polymer. Such cleaning polymers are believed to at least partially lift the stain from the textile fibres and enable the enzyme system to more effectively break up the complexes comprising mannan and other polysaccharide. Suitable cleaning polymers provide for broad-range soil cleaning of surfaces and fabrics and/or suspension of the soils. Non-limiting examples of suitable cleaning polymers include: amphiphilic alkoxylated grease cleaning polymers; clay soil cleaning polymers; soil release polymers; and soil suspending polymers. A preferred cleaning polymer is obtainable by free-radical copolymerization of at least one compound of formula (I),

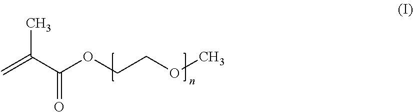

in which n is equal to or greater than 3 for a number,

with at least one compound of formula (II),

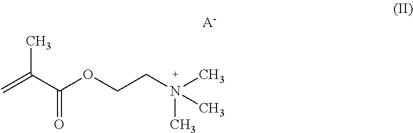

in which A⁻ represents an anion, in particular selected from halides such as fluoride, chloride, bromide, iodide, sulphate, hydrogen sulphate, alkyl sulphate such as methyl sulphate, and mixtures thereof. Such polymers are further described in EP3196283A1.

For similar reasons, polyester based soil release polymers, such as SRA300, supplied by Clariant are also particularly preferred.

Other useful cleaning polymers are described in US20090124528A1. The detergent composition may comprise amphiphilic alkoxylated grease cleaning polymers, which may have balanced hydrophilic and hydrophobic properties such that they remove grease particles from fabrics and surfaces. The amphiphilic alkoxylated grease cleaning polymers may comprise a core structure and a plurality of alkoxylate groups attached to that core structure. These may comprise alkoxylated polyalkyleneimines, for example. Such compounds may comprise, but are not limited to, ethoxylated polyethyleneimine, ethoxylated hexamethylene diamine, and sulphated versions thereof. Polypropoxylated derivatives may also be included. A wide variety of amines and polyalklyeneimines can be alkoxylated to various degrees. A useful example is 600 g/mol polyethyleneimine core ethoxylated to 20 EO groups per NH and is available from BASF. The alkoxylated polyalkyleneimines may have an inner polyethylene oxide block and an outer polypropylene oxide block. The detergent compositions may comprise from 0.1% to 10%, preferably, from 0.1% to 8.0%, more preferably from 0.1% to 2.0%, by weight of the detergent composition, of the cleaning polymer.

Dye transfer inhibiting polymers: The detergent composition can comprise one or more dye transfer inhibiting polymer. However, preferred compositions do not comprise such dye transfer inhibiting polymers. It has been found that during laundering, many fabric-dyes partition between the fabric and wash-liquor. As such, the sequestering of dyes in the wash liquor using DTI polymers has been found to increase dye removal from fabrics, and hence increase dye-fading.

When used, suitable dye transfer inhibiting can be selected from the group consisting of polyvinylpyrrolidone (PVP), polyvinylimidazole (PVI), copolymers of vinylpyrrolidone and vinylimidazole (PVP/PVI), polyvinyl pyridine-N-oxide, poly-N-carboxymethyl-4-vinylpyridiumchloride, poly(2-hydroxypropyldimethylammonium chloride), and mixtures thereof, preferably polyvinylpyrrolidone (PVP), polyvinylimidazole (PVI), copolymers of vinylpyrrolidone and vinylimidazole (PVP/PVI), and mixtures thereof. If present, the dye transfer inhibitor can be present at a level of from 0.05% to 5%, or from 0.1% to 3%, and or from 0.2% to 2.5%, by weight of the detergent composition.

Polyvinylpyrrolidone (“PVP”) has an amphiphilic character with a highly polar amide group conferring hydrophilic and polar attracting properties, and also has apolar methylene and methane groups, in the backbone and/or the ring, conferring hydrophobic properties. The rings may also provide planar alignment with the aromatic rings, in the dye molecules. PVP is readily soluble in aqueous and organic solvent systems. PVP is commercially available in either powder or aqueous solutions in several viscosity grades. The compositions of the present invention preferably utilize a copolymer of N-vinylpyrrolidone and N-vinylimidazole (also abbreviated herein as “PVPVI”). It has been found that copolymers of N-vinylpyrrolidone and N-vinylimidazole can provide excellent dye transfer inhibiting performance. The copolymers of N-vinylpyrrolidone and N-vinylimidazole can have a molar ratio of N-vinylimidazole to N-vinylpyrrolidone from 1:1 to 0.2:1, more preferably from 0.8:1 to 0.3:1, most preferably from 0.6:1 to 0.4:1. The copolymer of N-vinylpyrrolidone and N-vinylimidazole can be either linear or branched. Particularly suitable polyvinylpyrrolidones (PVP), polyvinylimidazoles (PVI), and copolymers of vinylpyrrolidone and vinylimidazole (PVP/PVI), can have a weight average molecular weight of from 5,000 Da to 1,000, 000 Da, preferably from 5,000 Da to 50,000 Da, more preferably from 10,000 Da to 20,000 Da. The number average molecular weight range is determined by light scattering as described in Barth J. H. G. and Mays J. W. Chemical Analysis Vol 1 13. “Modern Methods of Polymer Characterization.” Copolymers of poly (N-vinyl-2-pyrollidone) and poly (N-vinyl-imidazole) are commercially available from a number of sources including BASF. A preferred DTI is commercially available under the tradename Sokalan® HP 56 K from BASF (BASF SE, Germany).

Organic builder and/or chelant: The laundry detergent composition can comprise from 0.6% to 10%, preferably from 2 to 7% by weight of one or more organic builder and/or chelants. Suitable organic builders and/or chelants are selected from the group consisting of: MEA citrate, citric acid, aminoalkylenepoly(alkylene phosphonates), alkali metal ethane 1-hydroxy disphosphonates, and nitrilotrimethylene, phosphonates, diethylene triamine penta (methylene phosphonic acid) (DTPMP), ethylene diamine tetra(methylene phosphonic acid) (EDTMP), hexamethylene diamine tetra(methylene phosphonic acid), hydroxy-ethylene 1,1 diphosphonic acid (HEDP), hydroxyethane dimethylene phosphonic acid, ethylene di-amine di-succinic acid (EDDS), ethylene diamine tetraacetic acid (EDTA), hydroxyethylethylenediamine triacetate (HEDTA), nitrilotriacetate (NTA), methylglycinediacetate (MGDA), iminodisuccinate (IDS), hydroxyethyliminodisuccinate (HIDS), hydroxyethyliminodiacetate (HEIDA), glycine diacetate (GLDA), diethylene triamine pentaacetic acid (DTPA), catechol sulphonates such as Tiron™ and mixtures thereof.

Enzymes: Suitable enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, keratanases, reductases, oxidases, phenoloxidases, lipoxygenases, ligninases, pullulanases, tannases, pentosanases, malanases, B-glucanases, arabinosidases, hyaluronidase, chondroitinase, laccase, and known amylases, or combinations thereof. A preferred enzyme combination comprises a cocktail of conventional detersive enzymes such as protease, lipase, cutinase and/or cellulase in conjunction with amylase. Detersive enzymes are described in greater detail in U.S. Pat. No. 6,579,839.

Enzyme stabiliser: Enzymes can be stabilized using any known stabilizer system such as calcium and/or magnesium compounds, boron compounds and substituted boric acids, aromatic borate esters, peptides and peptide derivatives, polyols, low molecular weight carboxylates, relatively hydrophobic organic compounds [e.g. certain esters, diakyl glycol ethers, alcohols or alcohol alkoxylates], alkyl ether carboxylate in addition to a calcium ion source, benzamidine hypochlorite, lower aliphatic alcohols and carboxylic acids, N,N-bis(carboxymethyl) serine salts; (meth)acrylic acid-(meth)acrylic acid ester copolymer and PEG; lignin compound, polyamide oligomer, glycolic acid or its salts; poly hexa methylene bi guanide or N,N-bis-3-amino-propyl-dodecyl amine or salt; and mixtures thereof.

Hueing dyes: The detergent composition may comprise fabric hueing agent (sometimes referred to as shading, bluing, or whitening agents). Typically, the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and combinations thereof.

Optical brighteners: The detergent composition may comprise, based on the total detergent composition weight, from 0.005% to 2.0%, preferably 0.01% to 0.1% of a fluorescent agent (optical brightener). Fluorescent agents are well known and many fluorescent agents are available commercially. Usually, these fluorescent agents are supplied and used in the form of their alkali metal salts, for example, the sodium salts. Preferred classes of fluorescent agent are: Di-styryl biphenyl compounds, e.g. Tinopal® CBS-X, Di-amine stilbene di-sulphonic acid compounds, e.g. Tinopal® DMS pure Xtra and Blankophor® HRH, and Pyrazoline compounds, e.g. Blankophor® SN. Preferred fluorescers are: sodium 2-(4-styryl-3-sulphophenyl)-2H-napthol[1,2-d]trazole, disodium 4,4′-bis{[(4-anilino-6-(N methyl-N-2 hydroxyethyl) amino 1,3,5-triazin-2-yl)]amino}stilbene-2-2′ disulphonate, disodium 4,4′-bis{[(4-anilino-6-morpholino-1,3,5-triazin-2-yl)]annino} stilbene-2-2′ disulphonate, and disodium 4,4′-bis(2-sulphoslyryl)biphenyl.

Hydrotrope: The detergent composition may comprise, based on the total detergent composition weight, from 0 to 30%, preferably from 0.5 to 5%, more preferably from 1.0 to 3.0%, which can prevent liquid crystal formation. The addition of the hydrotrope thus aids the clarity/transparency of the composition. Suitable hydrotropes comprise but are not limited to urea, salts of benzene sulphonate, toluene sulphonate, xylene sulphonate or cumene sulphonate. Preferably, the hydrotrope is selected from the group consisting of propylene glycol, xylene sulphonate, ethanol, and urea to provide optimum performance.

Particles: The composition can also comprise particles, especially when the composition further comprises a structurant or thickener. The composition may comprise, based on the total composition weight, from 0.02% to 10%, preferably from 0.1% to 4.0%, more preferably from 0.25% to 2.5% of particles. Said particles include beads, pearlescent agents, capsules, and mixtures thereof.

Suitable capsules are typically formed by at least partially, preferably fully, surrounding a benefit agent with a wall material. Preferably, the capsule is a perfume capsule, wherein said benefit agent comprises one or more perfume raw materials. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, resorcinol-based materials, poly-isocyanate-based materials, acetals (such as 1,3,5-triol-benzene-gluteraldehyde and 1,3,5-triol-benzene melamine), starch, cellulose acetate phthalate and mixtures thereof. Preferably, the capsule wall comprises melamine and/or a polyacrylate based material. The perfume capsule may be coated with a deposition aid, a cationic polymer, a non-ionic polymer, an anionic polymer, or mixtures thereof. Preferably, the perfume capsules have a volume weighted mean particle size from 0.1 microns to 100 microns, preferably from 0.5 microns to 60 microns. Especially where the composition comprises capsules having a shell formed at least partially from formaldehyde, the composition can additionally comprise one or more formaldehyde scavengers.

### Process of Making the Laundry Detergent Composition

The laundry detergent compositions can be made using any suitable process known to the skilled person. Typically, the ingredients are blended together in any suitable order. Preferably, the detersive surfactants are added as part of a concentrated premix, to which are added the other optional ingredients. Preferably, the solvent is added either last, or if an external structurant is added, immediately before the external structurant, with the external structurant being added as the last ingredient.

### Method of Laundering Fabrics

The laundry detergent compositions of the present invention can be used to launder fabrics. In particular, the laundry detergent composition comprising the branched nonionic surfactant can be used for improving the color protection, preferably color retention, of colored fabrics during laundering.

The laundry detergent compositions of the present invention are particularly useful for preventing the removal of fabric-dyes selected from the group consisting of: reactive dyes, disperse dyes, and mixtures thereof, preferably wherein the fabric dyes are selected from the group consisting of: disperse dyes, reactive dyes, and mixtures thereof, from fabrics during the laundering process.

The compositions of the present invention are particularly effective for reducing the removal of dyes from fabrics comprising cotton, especially cotton-comprising fabrics having dyes selected from the group consisting of: reactive dyes, disperse dyes, direct dyes, vat dyes, and mixtures thereof; preferably wherein the reactive dyes are selected from the group consisting of: the reactive dyes are selected from the group consisting of: reactive black 5, reactive red 239, reactive red 195, the direct dyes are selected from the group consisting of: direct black 22, direct red 83, and the vat dyes are selected from the group consisting of: indigo (vat blue 1), sulphur black 1, and mixtures thereof. The compositions of the present invention are particularly useful for reducing the removal of dyes from cotton-comprising fabrics having dyes selected from the group consisting of: reactive dyes, especially reactive dyes selected from the group consisting of: reactive black 5, reactive red 239, and mixtures thereof.

The compositions of the present invention are also effective for reducing the removal of dyes from fabrics comprising polyester, especially polyester-comprising fabrics comprising disperse dyes selected from the group consisting of: disperse orange 30, disperse red 167, disperse blue 79, disperse red 60, and mixtures thereof, preferably disperse blue 79.

In such methods and uses, the laundry detergent composition can be diluted to provide a wash liquor having a total surfactant concentration of greater than 300 ppm, preferably from 400 ppm to 2,500 ppm, more preferably from 600 ppm to 1000 ppm. The fabric is then washed in the wash liquor, and preferably rinsed.

### METHODS

### A) pH Measurement

The pH is measured, at 25° C., using a Santarius PT-10P pH meter with gel-filled probe (such as the Toledo probe, part number 52 000 100), calibrated according to the instruction manual. The pH is measured in a 10% dilution in demineralised water (i.e. 1 part laundry detergent composition and 9 parts demineralised water).

B) Method of Measuring Viscosity

The viscosity is measured using an AR 2000 rheometer from TA instruments using a cone and plate geometry with a 40 mm diameter and an angle of 1°. The viscosity at the different shear rates is measured via a logarithmic shear rate sweep from 0.1 s⁻¹ to 1200 s⁻¹ in 3 minutes time at 20° C. Low shear viscosity is measured at a continuous shear rate of 0.05 s⁻¹.

### EXAMPLES

The following methodology was used to evaluate the impact of branched and linear nonionic surfactants on dye-bleeding during laundering.

Glass vials (size 4 ml) were filled with 2 ml of test detergent solutions, as described below, before subsequently inserting into a thermo-shaker (Echotherm° Orbital Shaker) set at the temperature of 40° C. The solutions were kept at this temperature for 15 minutes in order for the temperature to equilibrate.

The colored fabric samples as described below were cut into pieces of 150±1 mg (weighted using an analytical balance). These pieces had an area of circa 2.5×2.5 cm (depending on the fabric used). If needed, additional pieces of the same fabric were added to reach the target weight. Each textiles piece was folded and then inserted into the vials using a disposable glass stick, so that the fabric was fully covered by the solution, before returning the vial to the thermo-shaker.

The vials were continually shaken (using the medium speed setting) at temperature of 40° C. for 60 minutes. The vials were then removed from the thermo-shaker and the fabrics removed from the test detergent solutions. The solutions were kept in the dark for the time required to reach room temperature (25° C.).

The dye desorption was quantified as follows:

950 μl of each solution was placed into a semi-micro plastic cuvette and their absorbance spectra recorded using a UV-vis spectrophotometer (Cary UV-Vis Multicell Peltier, supplied by Agilent), measuring absorbance between 300 nm and 900 nm).

To each solution was added 50 μl of a 20 wt % aqueous solution of 2-[4-(2,4,4-trimethylpentan-2-yl)phenoxy]ethanol (Triton X-100, supplied by Sigma Aldrich) and the absorbance spectra between 300 nm and 900 nm was remeasured. The Triton X-100 was added as it was observed that, at the test concentrations used, Triton X-100 strongly reduced the scattering of the tested surfactants in the region overlapping the dye absorption spectra.

A calibration curve of each dye used was obtained using the following procedure:

Firstly, the following reference detergent solution was made:

A 350 ppm aqueous solution of equal weight parts of linear C10-C13 alkylbenzene sulphonic acid (HLAS), linear C12-C15 alkyl ethoxy (3.0) sulphate (AE3.0S), and linear C12-C14 E07 (Lorodac L726, supplied by Sasol) in water of hardness 2.67 mmol CaCO3 equivalence (CaCl₂ 1.93 mmol, MgCl₂ 0.64 mmol, 15 gpg) was prepared. The pH of the resultant solution was adjusted to 8.0 using ethanolamine.

2.0 ml of the composition was placed in the glass vial with 150 mg of each fabric, and washed using the procedure above, but at a temperature of 92° C. for 15 minutes.

After cooling to room temperature in the dark, 950 μl of the resultant solutions comprising desorbed dye were combined with 50 μl of a 20 wt % aqueous solution of 2-[4-(2,4,4-trimethylpentan-2-yl)phenoxy]ethanol (Triton X-100). The absorbance spectra were measured, as described above, and these solutions were arbitrary fixed as 95% dye desorption. The solutions were diluted in the following media: 95% of the above-described reference detergent solution combined with a 5% of Triton X-100 (20 wt %) to obtain a calibration curve for each dye used.

The values of absorbance (of the principal peak of the different dye samples) resulting from the desorption experiments were reported as a percentage of the value of same dye desorbed using the reference detergent solution at 92° C. in the calibration procedure described above.

The following solutions were evaluated for their impact on dye bleeding for both dyed cotton fabric (cotton fabric dyed using reactive black 5, supplied by CFT under product code AISE code 21) and dyed polyester fabric (polyester fabric dyed using disperse blue 79, supplied by CFT under product code AISE code 31), and the results given below. Apart from Leg A and F (water), the solutions used in the remaining legs comprised 350 ppm of surfactant.

TABLE 1
% Desorption @ 40° C. (after 1 hour) vs. desorption at 92° C.
using the reference detergent solution for cotton fabrics

| | | % desorption |
|---|---|---|
| | | of reactive |
| | | black 5 dye |
| Leg | Test solution | from cotton |
| A | water¹ | 46.8 |
| B | reference detergent solution² | 64.9 |
| C | linear C12-C14 EO7³ | 72.4 |
| D | 2-propyl-1-heptyl EO7⁴ | 51.1 |
| E | 2-propyl-1-heptyl (PO)3(EO)12(PO)15⁵ | 47.4 |

¹ hardness 2.67 mmol CaCO₃ equivalence (15 gpg)
²1:1:1 weight ratio of linear C10-C13 alkylbenzene sulphonic acid (HLAS), linear C12-C15 alkyl ethoxy (3.0) sulphate (AE3.0S), and linear C12-C14 EO7 (Lordac ® L726, supplied by Sasol)
³Lordac ® L726, supplied by Sasol
⁴Lutensol ® XP70, supplied by BASF
⁵Plurafac ® SLF180, supplied by BASF

TABLE 2
% Desorption @ 40° C. (after 1 hour) vs. desorption at 92° C.
using the reference detergent solution for polyester fabrics

| | | % desorption |
|---|---|---|
| | | of disperse |
| | | blue 79 dye |
| Leg | Test solution | from polyester |
| F | water¹ | 8.5 |
| G | reference detergent solution² | 50.3 |
| H | linear C12-C14 EO7³ | 65.7 |
| I | 2-propyl-1-heptyl EO7⁴ | 10.3 |
| J | 2-propyl-1-heptyl (PO)3 | 12.4 |
| | (EO)12(PO)15⁵ | |

The effect on detergents on dye bleeding from fabric during laundering can be seen from comparing the dye desorption from leg B with leg A for cotton fabrics and leg G with leg F for polyester fabrics.

From comparing the dye-bleeding from legs D and E with leg C, it can be seen that branched nonionic surfactants provide reduced dye bleeding than linear branched nonionic surfactants when laundering cottons. A comparison of legs I and J with leg H demonstrates the same benefit for branched nonionics when laundering polyester fabrics.

From legs B and G, it can be seen that dye bleeding is lower for both cotton ands polyester fabrics when the wash temperature is reduced (from 92° C. to 40° C.).

The following comparative test demonstrates the reduction in dye bleeding during laundering when using the compositions of the present invention.

The following compositions were prepared by simple mixing.

TABLE 3
Comparative laundry liquid compositions (examples A and B
and inventive laundry liquid composition (example 1)

| | Ex A | Ex B | Ex 1 |
|---|---|---|---|
| | wt % | wt % | wt % |
| C10-C13 linear alkyl | 3.6 | 3.6 | 3.6 |
| benzene sulphonate | | | |
| C12-C15 AE3.0S | 2.5 | 2.5 | 2.5 |
| linear C12-C14 EO7³ | 2.2 | 2.2 | — |
| 2-propyl-1-heptyl EO7⁴ | — | — | 2.2 |
| C12-C14 dimethyl aminoxide | 0.33 | 0.33 | 0.33 |
| TPK Fatty Acid | 2.16 | 2.16 | 2.16 |
| Citric Acid | 1.7 | 1.7 | 1.7 |
| Polyquaternium 22⁶ | — | 1.4 | 1.4 |
| PEG-PVAc Polymer⁷ | 0.5 | 0.5 | 0.5 |
| Enzymes | 0.006 | 0.006 | 0.006 |
| Ethylene diamine tetra(methylene | 0.55 | 0.55 | 0.55 |
| phosphonic) acid (EDTMP) | | | |
| Perfume | 0.82 | 0.82 | 0.82 |
| Water | to | to | to |
| | 100% | 100% | 100% |

⁶cationic polymer Merquat 281, molecular weight 450,000 Da, supplied by Lubrizol
⁷Polyvinyl acetate grafted polyethylene oxide copolymer having a polyethylene oxide backbone and multiple polyvinyl acetate side chains, supplied by BASF, Germany

Cotton fabrics pre-dyed with reactive red 239 (AISE 17, supplied by CFT) were cut into 6 cm×6 cm pieces. If needed to avoid fraying of the fabric edges, a plastic edging was applied with heat to the fabric squares.

Tergotometer pots were filled with 4.3 grs of each example composition and water (hardness 2.67 mmol CaCO3 equivalence (15 gpg)) added to form 1 L of wash liquor. To each tergotometer pot was added the following fabric swatches:
3 swatches of reactive red 239
ballast of 5gr of black cotton
ballast of 3 grs black polyester
other colored 6×6 cm swatches until a total fabric load of 45 g is reached

The tergotometer pots were heated to a temperature of 60° C. and agitated at a rate of 300 rpm for 40 minutes. After the wash, the test fabrics and ballast were spun at a speed of 1000 rpm for 2 minutes before rinsing twice in water at a temperature of 20° C. and hardness 2.67 mmol CaCO3 equivalence (15 gpg) for 5 minutes, with a spin step of 1000 rpm for 2 minutes after each rinse step. In a final step, the fabrics were them tumble-dried. The laundering cycles were repeated for a total of 5 cycles.

The test swatches were analysed for colour change versus an unwashed reference fabric using a spectrophotometer (Konika Minolta CM-3610A) and the change in colour measured on the ΔE CMC scale. The results are given in table 4 below.

Each pot contained three pieces of each of the test fabrics (three internal replicates); each composition was added to two different pots (two external replicates), ΔE CMC readings were averaged for each treatment.

TABLE 4
ΔE CMC for washed fabric vs. unwashed fabric
(lower value corresponds to less fading)

| | Reactive |
|---|---|
| | Red 239 |
| | Cotton fabric |
| Ex A (comprising linear | 4.6 |
| nonionic surfactant and | |
| no cationic polymer) | |
| Ex B (comprising linear | 4.2 s* |
| nonionic surfactant and | |
| cationic polymer) | |
| Ex 1 (comprising branched | 3.9 s* |
| nonionic surfactant and | |
| cationic polymer) | |

*significancy calculated vs Ex A via Anova HSD with alpha = 0.05

As can be seen from the data above, laundering with the composition of the present invention (example 1) resulted in less dye fading than from comparative compositions which comprised a cationic polymer and linear nonionic surfactant (example B) or no cationic polymer and a nonionic surfactant.

TABLE 5
further examples of compositions of the present invention.

| | Ex 2 | Ex 3 | Ex 4 |
|---|---|---|---|
| | wt % | wt % | wt % |
| C10-C13 linear alkyl benzene sulphonate | 5 | 3 | 3.6 |
| C12-C15 AE3.0S | 2.2 | 3 | 2.2 |
| linear C12-C14 EO7³ | — | — | — |
| 2-propyl-1-heptyl EO7⁴ | — | 3 | — |
| 2-propyl-1-heptyl (PO)3(EO)12(PO)15⁵ | 1.9 | | 2.5 |
| C12-C14 dimethyl aminoxide | 0.5 | 0.1 | 0.4 |
| TPK Fatty Acid | 1 | 0.5 | 2 |
| Citric Acid | 1 | 0.5 | 1.5 |
| Polyquaternium 22⁶ | — | — | 1.5 |
| Polyquaternium 7⁸ | 1 | 0.5 | — |
| PEG-PVAc Polymer⁷ | 0.5 | 0.2 | 0.3 |
| Enzymes | 0.1001 | 0.001 | 0.001 |
| Ethylene diamine tetra(methylene | 0.5 | 0.4 | 0.3 |
| phosphonic) acid (EDTMP) | | | |
| Perfume | 1.0 | 0.8 | 1.2 |
| Water | to | to | to |
| | 100% | 100% | 100% |

⁸poly(diallyldimethylammonium chloride/acrylamide), Merquat 740, molecular weight 100,000 Da, supplied by Lubrizol

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry detergent composition comprising a surfactant system and cationic polymer, wherein
the surfactant system comprises: a branched nonionic surfactant, and
wherein the cationic polymer is selected from: poly (diallyldimethylammonium chloride); copolymer of diallyldimethylammonium chloride and acrylic acid; copolymer of acrylamide and methacrylamidopropyltrimethyl ammonium chloride; copolymer of acrylamide and diallyldimethylammonium chloride; copolymer of methacrylate, methacrylamidopropyltrimethyl ammonium chloride and acrylic acid; copolymer of acrylamide, methacrylamidopropyltrimethyl ammonium chloride and acrylic acid; copolymer of acrylamide, diallyldimethylammonium chloride, and acrylic acid; copolymer of acrylamide and N,N, N-trimethyl aminoethyl acrylate; copolymer of diallyldimethylammonium chloride and vinyl alcohol, and mixtures thereof,
wherein the cationic polymer has a molecular weight of from about 1,000 Da to about 1,250,000 Da,
wherein the branched nonionic surfactant is selected from:
R1—CH(R2)—O—(PO)ₓ(EO)_{y}(PO)_{z}—H a) Formula I:
wherein, in Formula I:
R1 is a C4 to C14 alkyl chain;
R2 is a C1 to C7 alkyl chain;
x is from about 0 to about 10;
y is from about 5 to about 20;
z is from about 0 to about 20;
EO stands for ethoxylation and PO stands for propoxylation;
R1—CH(R2)CH2—O—(PO)ₓ(EO)_{y}(PO)_{z}—H b) Formula II:
wherein in formula II:
R1 is a C3 to C13 alkyl chain;
R2 is a Cl to C7 alkyl chain;
x is from about 0 to about 10;
y is from about 5 to about 20;
z is from about 0 to about 20;
EO stands for ethoxylation and PO stands for propoxylation;
c) or mixtures thereof.

2. The laundry detergent composition according to claim 1, wherein:
a) in formula I:
R1 is a C4 to C8 alkyl chain;
R2 is a C1 to C5 alkyl chain;
x is from about 0 to about 5;
y is from about 6 to about 15; and
z is from about 0 to about 5;
b) in formula II:
R1 is a C3 to C7 alkyl chain;
R2 is a C1 to C5 alkyl chain;
x is from about 0 to about 6;
y is from about 6 to about 15;
z is from about 0 to about 5.

3. The laundry detergent composition according to claim 1, wherein surfactant system comprises the branched nonionic surfactant at a level of from about 0.1% to about 12% by weight of the composition.

4. The laundry detergent composition according to claim 3, wherein surfactant system comprises the branched nonionic surfactant at a level of from about 0.5% to about 10% by weight of the composition.

5. The laundry detergent composition according to claim 1, wherein the laundry composition comprises the surfactant system at a level of from about 1 wt % to about 70 wt %.

6. The laundry detergent composition according to claim 1, wherein the surfactant system further comprises an anionic surfactant, wherein the anionic surfactant comprises: sulphonate surfactant, sulphate surfactant, or mixtures thereof.

7. The laundry detergent composition according to claim 6, wherein the anionic surfactant comprises alkyl sulphate surfactant, wherein the alkyl sulphate surfactant has an average degree of ethoxylation of from about 0.5 to about 8.0.

8. The laundry detergent composition according to claim 6, wherein the anionic surfactant comprises alkyl sulphate surfactant, wherein the alkyl sulphate surfactant has an average degree of ethoxylation of less than 0.5.

9. The laundry detergent composition according to claim 8, wherein the alkyl sulphate surfactant comprises branched alkyl sulphate surfactant, wherein the branched alkyl sulphate surfactant comprises at least about 20% by weight of the alkyl chains of the branched alkyl sulphate surfactant of 2-branched alkyl chains.

10. The laundry detergent composition according to claim 1, wherein the surfactant system comprises amphoteric and/or zwitterionic surfactant.

11. The laundry detergent composition according to claim 10, wherein the amphoteric surfactant is selected from amine oxide surfactant.

12. The laundry detergent composition according to claim 1, wherein the cationic polymer is selected from the group consisting of: the cationic polymer is selected from: poly (diallyldimethylammonium chloride); copolymer of diallyldimethylammonium chloride and acrylic acid; copolymer of methacrylate, methacrylamidopropyltrimethyl ammonium chloride and acrylic acid; and mixtures thereof.

13. The laundry detergent composition according to claim 12, wherein the cationic polymer is a copolymer of diallyldimethylammonium chloride and acrylic acid.

14. The laundry detergent composition according to claim 1, wherein the diallyldimethylammonium chloride and co-acrylic acid monomers are present in a mol ratio of from about 50:50 to about 90:10.

15. The laundry detergent composition according to claim 14, wherein the diallyldimethylammonium chloride and co-acrylic acid monomers are present in a mol ratio of from about 55:45 to about 85:15.

16. The laundry detergent composition according to claim 1, wherein the cationic polymer has a molecular weight of from about 100,000 Da to about 1,000,000 Da.

17. The laundry detergent composition according to claim 16, wherein the cationic polymer has a molecular weight of from about 250,000 Da to about 750,000 Da.

18. The laundry detergent composition according to claim 1, wherein the cationic polymer is present at a level of from about 0.1% to about 10% by weight of the composition.

19. The laundry detergent composition according to claim 18, wherein the cationic polymer is present at a level of from about 1.0% to about 2.5% by weight of the composition.

20. The laundry detergent composition according to claim 1, wherein:
the cationic polymer is a copolymer of diallyldimethylammonium chloride and acrylic acid, and the cationic polymer has a molecular weight of from about 250,000 Da to about 750,000 Da;
the surfactant system comprises:
a branched nonionic surfactant selected from:
R1—CH(R2)—O—(PO)ₓ(EO)_{y}(PO)_{z}—H a) Formula I:
wherein, in Formula I:
R1 is a C4 to C8 alkyl chain;
R2 is a C1 to C5 alkyl chain;
x is from about 0 to about 5;
y is from about 6 to about 15; and
z is from about 0 to about 5;
R1—CH(R2)CH₂—O—(PO)ₓ(EO)_{y}(PO)_{z}—H b) Formula II:
wherein in formula II:
R1 is a C3 to C7 alkyl chain;
R2 is a C1 to C5 alkyl chain;
x is from about 0 to about 6;
y is from about 6 to about 15;
z is from about 0 to about 5;
c) or mixtures thereof.
the surfactant system further comprises anionic surfactant and amphoteric surfactant, wherein:
the anionic surfactant comprises: sulphonate surfactant and sulphate surfactant; and
the amphoteric surfactant is selected from amine oxide surfactant.
